(19) United States
(12) Patent Application Publication
(10) Pub. No.: US 2015/0007033 A1
(43) Pub. Date: Jan. 1, 2015

(54) VIRTUAL MICROSCOPE TOOL

(71) Applicant: Lucid Global, LLC., Sarasota, FL (US)

(72) Inventors: Lawrence Kiey, Downingtown, PA (US); Dale Park, Poway, CA (US); Richard Browne, OLd Brookville, NY (US); Jeffrey Hazelton, Sarasota, FL (US)

(73) Assignee: Lucid Global, LLC., Sarasota, FL (US)

(21) Appl. No.: 14/179,020

(22) Filed: Feb. 12, 2014

Related U.S. Application Data
(63) Continuation-in-part of application No. 13/927,822, filed on Jun. 26, 2013.

(51) Int. Cl. G06F 3/0484

(52) U.S. Cl. CPC G06F 3/0484
USPC 715/723

(57) ABSTRACT

Various exemplary embodiments relate to a method and related devices including one or more of the following: displaying, on a display of the authoring device, a first representation of a first environment, wherein the first environment represents an anatomical structure; receiving, via a user input interface of the authoring device, a first user input representing a request to initiate a portal; in response to receiving the first user input, displaying, on the output device a first compound representation comprising: the first representation of the first environment, a portal frame, and a second representation of a second environment, wherein the second environment represents the anatomical structure and is located within the portal frame; and generating a video file, wherein the video file enables playback of the first compound representation.

### CROSS-REFERENCE TO RELATED APPLICATIONS

This application is a continuation-in-part of application Ser. No. 13/927,822 filed on Jun. 26, 2013, the entire disclosure of which is hereby incorporated for all purposes as if fully set forth herein.

### TECHNICAL FIELD

Various exemplary embodiments disclosed herein relate generally to digital presentations.

### BACKGROUND

Medical environments may be used to help describe or communicate information such as chemical, biological, and physiological structures, phenomena, and events. Until recently, traditional medical environments have consisted of drawings or polymer-based physical structures. However, because such models are static, the extent of description or communication that they may facilitate is limited. While some drawing models may include multiple panes and while some physical models may include colored or removable components, these models are poorly suited for describing or communicating dynamic chemical, biological, and physiological structures or processes. For example, such models poorly describe or communicate events that occur across multiple levels of organization, such as one or more of atomic, molecular, macromolecular, cellular, tissue, organ, and organism levels of organization, or across multiple structures in a level of organization, such as multiple macromolecules in a cell.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by an authoring device for creating a digital medical presentation, the method including: displaying, on a display of the authoring device, a first representation of a first environment, wherein the first environment represents an anatomical structure; receiving, via a user input interface of the authoring device, a first user input representing a request to initiate a portal; in response to receiving the first user input, displaying, on the output device a first compound representation including: the first representation of the first environment, a portal frame, and a second representation of a second environment, wherein the second environment represents the anatomical structure and is located within the portal frame; and generating a video file, wherein the video file enables playback of the first compound representation.

Various embodiments described herein relate to a non-transitory machine-readable storage medium encoded with instructions for execution by an authoring device for creating a digital medical presentation, the non-transitory machine-readable storage medium including: instructions for displaying, on a display of the authoring device, a first representation of a first environment, wherein the first environment represents an anatomical structure; instructions for receiving, via a user input interface of the authoring device, a first user input representing a request to initiate a portal; instructions for, in response to receiving the first user input, displaying, on the output device a first compound representation including: the first representation of the first environment, a portal frame, and a second representation of a second environment, wherein the second environment represents the anatomical structure and is located within the portal frame; and instructions for generating a video file, wherein the video file enables playback of the first compound representation.

Various embodiments described herein relate to a device for creating a digital medical presentation, the device including: a user input interface, a display device, and a processor configured to display, on the display device, a first representation of a first environment, wherein the first environment represents an anatomical structure; receive, via the user input interface, a first user input representing a request to initiate a portal; in response to receiving the first user input, display, on the output device a first compound representation including: the first representation of the first environment, a portal frame, and a second representation of a second environment, wherein the second environment represents the anatomical structure and is located within the portal frame; and generate a video file, wherein the video file enables playback of the first compound representation.

Various embodiments are described wherein the first environment represents the anatomical structure at a first magnification level and the second environment represents the anatomical structure at a second magnification level that is greater than the first magnification level.

Various embodiments are described wherein, in the first compound representation, the portal frame and second representation partially occlude the first representation.

Various embodiments additionally include receiving, via a user input interface of the authoring device, a second user input representing a request to change an environment of the first compound representation; and in response to receiving the second user input, displaying, on the output device a second compound representation including: the first representation of the first environment, the portal frame, and a third representation of a third environment, wherein the third environment represents the anatomical structure, is located within the portal frame, and is different from the second representation; whereby the video file additionally enables playback of the second compound representation.

Various embodiments are described wherein: the portal frame includes at least two magnification buttons representative of respective magnification levels; the second user input includes selection of a selected magnification button of the at least two magnification buttons; and the third environment represents the anatomical structure at the magnification level represented by the selected magnification button.

Various embodiments additionally include receiving, via a user input interface of the authoring device, a second user input representing a request to modify the second environment; and in response to receiving the second user input, effecting a first modification to the simulation underlying the second representation, whereby the video file additionally enables playback of the second representation after effecting the first modification to the second environment.

Various embodiments are described wherein the first modification includes at least one of administering a medication, inducing a medical condition, simulating a slide stain, and simulating a treatment.

Various embodiments are described wherein: the frame includes a tool palette including at least a first button associated with the modification and a second button associated with no modification; and the second user input includes selection of the first button.

Various embodiments additionally include in response to receiving the second user input: identifying a second modification associated with the first modification; and effecting the second modification to the first environment, whereby the video file additionally enables playback of the first representation as part of the first compound representation after effecting the second modification to the first environment.

Various embodiments are described wherein: the second user input includes the user repositioning the portal frame with respect to the first representation; and the first modification includes moving a camera associated with the second environment based on the repositioning of the portal frame, whereby the video file additionally enables playback of the second representation after effecting the movement of the camera.

The subject matter described herein may be useful in various industries, including the medical- and science-based industries, as a new platform for communicating biological concepts and phenomena. In one aspect, the present invention features an immersive virtual medical environment. Medical environments allow for the display of real-time, computer-generated medical environments in which a user may view a virtual environment of a biological structure or a biological event, such as a beating heart, an operating kidney, a physiologic response, or a drug effect, all within a high-resolution virtual space. Unlike traditional medical simulations, medical environments allow a user to actively navigate and explore the biological structure or biological event and thereby select or determine an output in real time. Accordingly, medical environments provide a powerful tool for users to communicate and understand any aspect of science.

Various embodiments allow user to record and save their navigation and exploration choices so that user-defined output may be displayed to or exported to other users. Optionally, the user may include user-defined audio voice-over, captions, or highlighting with the user-defined output. In certain embodiments, the system may include a custom virtual environment programmed to medically-accurate specifications.

In another aspect, the invention may include an integrated system that includes a library of environments and that is designed to allow a user to communicate dynamic aspects of various biological structures or processes. Users may include, for example, physicians, clinicians, researchers, professors, students, sales representatives, educational institutions, research institutions, companies, television programs, news outlets, and any party interested in communicating a biological concept.

Medical simulation provides users with a first-person interactive experience within a dynamic computer environment. The environment may be rendered by a graphics software engine that produces images in real time and is responsive to user actions. In certain embodiments, medical environments allow users to make and execute navigation commands within the environment and to record the output of the user's navigation. The user-defined output may be displayed or exported to another party, for example, as a user-defined medical animation. In some embodiments, a user may begin by launching a core environment. Then, the user may view and navigate the environment. The navigation may include, for example, one or more of (a) directionally navigating from one virtual object to a second virtual object in the medical environment; (b) navigating about the surface of a virtual object in the virtual medical environment; (c) navigating from inside to outside (or from outside to inside) a virtual object in the virtual medical environment; (d) navigating from an aspect at one level of organization to an aspect at second level of organization of a virtual object in the virtual medical environment; (e) navigating to a still image in a virtual medical environment; (f) navigating acceleration or deceleration of the viewing speed in a virtual medical environment; and (g) navigation specific to a particular environment. In addition, the user may add, in real-time or later in a recording session, one or more of audio voice-over, captions, and highlighting. The user may record his or her navigation output and optional voice-over, caption, or highlight input. Then, the user may select to display his or her recorded output or export his or her recorded output.

In certain embodiments, the system is or includes software that delivers real-time medical environments to serve as an interactive teaching and learning tool. The tool is specifically useful to aid in the visualization and communication of dynamic concepts in biology or medical science. Users may create user-defined output, as described above, for educating or communicating to oneself or another, such as a patient, student, peer, customer, employee, or any audience. For example, a user-defined output from a medical simulation may be associated with a patient file to remind the physician or to communicate or memorialize for other physicians or clinicians the patient's condition. An environment or a user-defined output from a medical simulation may be used when a physician explains a patient's medical diagnosis to the patient. A medical simulation or user-defined output from a medical simulation may be used as part of a presentation or lecture to patients, students, peers, colleagues, customers, viewers, or any audience.

Medical simulations may be provided as a single product or an integrated platform designed to support a growing library of individual virtual medical environments. As a single product, medical simulations may be described as a virtual medical environment in which the end-user initially interacts with a distinct biological structure, such as a human organ, or a biological event, such as a physiologic function, to visualize and navigate various aspects of the structure or event. A medical simulation may provide a first-person, interactive and computerized environment in which users possess navigation control for viewing and interacting with a functional model of a biological structure, such as an organ, tissue, or macromolecule, or a biological event. Accordingly, in certain embodiments, medical simulations are provided as part of an individual software program that operates with a user's computer to display on a graphical interface a virtual medical environment and allows the user to navigate the environment, to record the navigation output (e.g., as a medical animation), and, optionally, to add user-defined input to the recording and, thus, to the user-defined output.

The medical simulation software may be delivered to a computer via any method known in the art, for example, by Internet download or by delivery via any recordable medium such as, for example, a compact disk, digital disk, or flash drive device. In certain embodiments, the medical simulation software program may be run independent of third party software or independent of internet connectivity. In certain embodiments, the medical simulation software may be compatible with third party software, for example, with a Windows operating system, Apple operating system, CAD software, an electronic medical records system, or various video game consoles (e.g., the Microsoft Xbox or Sony Playstation). In certain embodiments, medical simulations may be provided by an “app” or application on a cell phone, smart phone, PDA, tablet, or other handheld or mobile computer device. In certain embodiments, the medical simulation software may be inoperable or partially operable in the absence of internet connectivity.

As an integrated product platform, medical simulations may be provided through a library of medical environments and may incorporate internet connectivity to facilitate user-user or user-service provider communication. For example, in certain embodiments, a first virtual medical environment may allow a user to launch a Supplement to the first medical environment or it may allow the user to launch a second medical environment regarding a related or unrelated biological structure or event, or it may allow a user to access additional material, information, or links to web pages and service providers. Updates to environments may occur automatically and users may be presented with opportunities to participate in sponsored programs, product information, and promotions. In this sense, medical simulation software may include a portal for permission marketing.

From the perspective of the user, medical environments may be the driving force behind the medical simulations platform. An environment may correspond to any one or more biological structures or biological events. For example, an environment may include one or more specific structures, such as one or more atoms, molecules, macromolecules, cells, tissues, organs, and organisms, or one or more biological events or processes. Examples of environments include a virtual environment of a functioning human heart; a virtual environment of a functioning human kidney; a virtual environment of a functioning human joint; a virtual environment of an active neuron or a neuronal net; a virtual environment of a seeing eyeball; and a virtual environment of a growing solid tumor.

In certain embodiments, each environment of a biological structure or biological event may serve as a core environment and provide basic functionality for the specific subject of the environment. For example, with the heart environment, users may freely navigate around a beating heart and view it from any angle. The user may choose to record his or her selected input and save it to a non-transitory computer-readable medium and or export it for later viewing.

As mentioned above, medical simulations allow user to navigate a virtual medical environment, record the navigation output, and, optionally, add additional input such as voice-over, captions, or highlighting to the output. Navigation of the virtual medical environment by the user may be performed by any method known in the art for manipulating an image on any computer screen, including PDA and cell phone screens. For example, navigation may be activated using one or more of: (a) a keyboard, for example, to type word commands or to keystroke single commands; (b) activatable buttons displayed on the screen and activated via touchscreen or mouse; (c) a multifunctional navigation tool displayed on the screen and having various portions or aspects activatable via touchscreen or mouse; (d) a toolbar or command center displayed on the screen that includes activatable buttons, portions, or text boxes activated by touchscreen or mouse, and (e) a portion of the virtual environment that itself is activatable or that, when the screen is touched or the mouse cursor is applied to it, may produce a window with activatable buttons, optionally activated by a second touch or mouse click.

The navigation tools may include any combination of activatable buttons, object portions, keyboard commands, or other features that allow a user to execute corresponding navigation commands. The navigation tools available to a user may include, for example, one or more tools for: (a) directionally navigating from one virtual object to a second virtual object in the medical environment; (b) navigating about the surface of a virtual object in the virtual medical environment; (c) navigating from inside to outside (or from outside to inside) a virtual object in the virtual medical environment; (d) navigating from an aspect at one level of organization to an aspect at second level of organization of a virtual object in the virtual medical environment; (e) navigating to a still image in a virtual medical environment; (f) navigating acceleration or deceleration of the viewing speed in a virtual medical environment; and (g) executing navigation commands that are specific to a particular environment. Additional navigation commands and corresponding tools available for an environment may include, for example, a command and tool with the heart environment to make the heart translucent to better view blood movement through the chambers.

In addition, the navigation tools may include one or more tools to activate one or more of: (a) recording output associated with a user's navigation decisions; (b) supplying audio voiceover to the user output; (c) supplying captions to the user output; (d) supplying highlighting to the user output; (e) displaying the user's recorded output; and (f) exporting the user's recorded output.

In certain embodiments, virtual medical environments are but one component of an integrated system. For example, a system may include a library of environments. In addition, various components of a system may include one or more of the following components: (a) medical environments; (b) control panel or “viewer;” (c) Supplements; and (d) one or more databases. The virtual medical environment components have been described above as individual environments. The viewer component, the Supplements component, and the database component are described in more detail below.

Users may access one or more environments from among a plurality of environments. For example, a particular physician may wish to acquire one or both of the Heart environment and the Liver environment. In certain embodiments, users may obtain a full library of environments. In certain embodiments, a viewer may be included as a central utility tool that allows users to organize and manage their environments, as well as manage their interactions with other users, download updates, or access other content.

From a user's perspective, the viewer may be an organization center and it may be the place where users launch their individual environments. In the background, the viewer may do much more. For example, back-end database management known in the art may be used to support the various services and two-way communication that may be implemented via the viewer. For example, as an application, the viewer may perform one or more of the following functions: (a) launch one or more environments or Supplements; (b) organize any number of environments or Supplements; (c) detect and use an internet connection, optionally automatically; (e) contain a Message Center for communications to and from the user; (f) download (acquire) new environments or content; (g) update existing environments, optionally automatically when internet connectivity is detected; and (h) provide access to other content, such as web pages and internet links, for example, Medline or journal article web links, or databases such as patient record databases.

The viewer may include discrete sections to host various functions. For example the viewer may include a Launch Center for organization and maintenance of the library for each user. Environments that users elect to install may be housed and organized in the Launch Center. Each environment may be represented by an icon and title (e.g., Heart).

The viewer may include a Control Center. The Control center may include controls that allow the user to perform actions, such as, for example, one or more of registration, setting user settings, contacting a service provider, linking to a web site, linking to an download library, navigating an environment, recording a navigation session, and supplying additional input to the user's recorded navigation output. In certain embodiments, the actions that are available to the user may be set to be status dependent.

The viewer may include a Message Center having a message window for users to receive notifications, invitations, or announcements from service providers. Some messages may be simple notifications and some may have the capability to launch specific activities if accepted by the user. As such, the Message Center may include an interactive feedback capability. Messages pushed to the Message Center may have the capability to launch activities such as linking to external web sites (e.g., opening in a new window) or initiating a download. The Message Center also may allow users to craft their own messages to a service provider.

As described, core environments may provide basic functionality for a specific medical structure. In certain embodiments, this functionality may be extended into a specialized application, or Supplement, which is a module that may be added to one or more core environments. Just as there are a large number of core environments that may be created, the number of potential Supplements that may be created is many fold greater, since each environment may support its own library of Supplements. Additional Supplements may include, for example, viewing methotrexate therapy, induction of glomerular sclerosis, or a simulated myocardial infarction, within the core environment. Supplements may act as custom-designed plug-in modules and may focus on a specific topic, for example, mechanism of action or disease etiology. Tools for activating a Supplement may be the same as any of the navigation tools described above. For example, a Neoplasm core environment may be associated with three Supplements that may be activated via an activatable feature of the environment.

In certain embodiments, the system is centralized around a viewer or other application that may reside on the user's computer or mobile device and that may provide a single window where the activities of each user are organized. In the background, the viewer may detect an Internet connection and may establish a communication link between the user's computer and a server.

On the server, a secure database application may monitor and track information retrieved from relative applications of all users. Most of the communications may occur in the background and may be transparent to the user. The communication link may be “permission based,” meaning that the user may have the ability to deny access.

The database application may manage all activities relating to communications between the server and the universe of users. It may allow the server to push selected information out to all users or to a select group of users. It also may manage the pull of information from all users or from a select group of users. The “push/pull” communication link between users and a central server allows for a host of communications between the server and one or more users.

### BRIEF DESCRIPTION OF THE DRAWINGS

In order to better understand various exemplary embodiments, reference is made to the accompanying drawings, wherein:

FIG. 1 illustrates an exemplary system for creating and viewing presentations;

FIG. 2 illustrates an exemplary process flow for creating and viewing presentations;

FIG. 3 illustrates an exemplary hardware device for creating or viewing presentations;

FIG. 4 illustrates an exemplary arrangement of environments and supplements for use in creating presentations;

FIG. 5 illustrates an exemplary method for recording user interaction with environments and supplements;

FIG. 6 illustrates an exemplary graphical user interface for recording interaction with environments and supplements;

FIG. 7 illustrates an exemplary graphical user interface for displaying and recording a microscope tool;

FIG. 8 illustrates an exemplary method for toggling recording mode for environments and supplements;

FIG. 9 illustrates an exemplary method for outputting image data to a video file;

FIG. 10 illustrates an exemplary method for processing microscope tool input;

FIG. 11 illustrates an exemplary method for drawing a microscope tool;

FIG. 12 illustrates an exemplary data arrangement for storing environment associations; and

FIG. 13 illustrates an exemplary method for sharing state information between environments.

### DETAILED DESCRIPTION

Referring now to the drawings, in which like numerals refer to like components or steps, there are disclosed broad aspects of various exemplary embodiments. The term, “or,” as used herein, refers to a non-exclusive or (i.e., and/or), unless otherwise indicated (e.g., “or else” or “or in the alternative”). It will be understood that the various embodiments described herein are not necessarily mutually exclusive, as some embodiments may be combined with one or more other embodiments to form new embodiments.

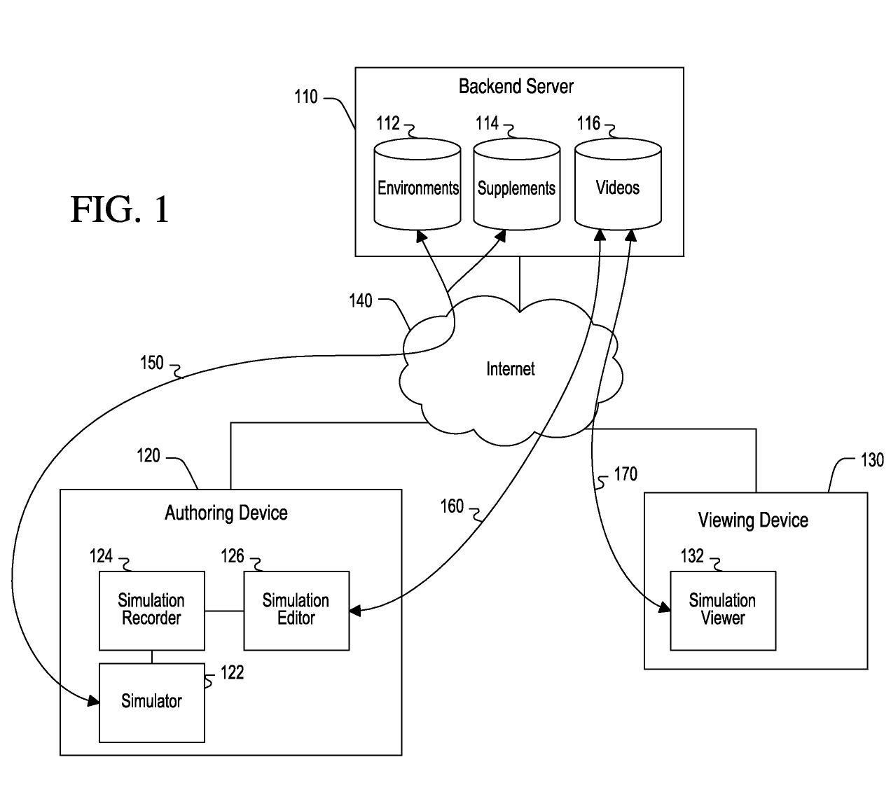

FIG. 1 illustrates an exemplary system 100 for creating and viewing presentations. The system may include multiple devices such as a backend server 110, an authoring device 120, or a viewing device 130 in communication via a network such as the Internet 140. It will be understood that various embodiments may include more or fewer of a particular type of device. For example, some embodiments may not include a backend server 110 and may include multiple viewing devices.

The backend server 110 may be any device capable of providing information to one or more authoring devices 120 or viewing devices 130. As such, the backend server 110 may include, for example, a personal computer, laptop, server, blade, cloud device, tablet, or set top box. Various additional hardware devices for implementing the backend server 110 will be apparent. The backend server 110 may also include one or more storage devices 112, 114, 116 for storing data to be served to other devices. Thus, the storage devices 112, 114, 116 may include a machine-readable storage medium such as read-only memory (ROM), random-access memory (RAM), magnetic disk storage media, optical storage media, flash-memory devices, or similar storage media. The storage devices 112, 114, 116 may store information such as environments and supplements for use by the authoring device 120 and videos for use by the viewing device 130.

The authoring device 120 may be any device capable of creating and editing presentation videos. As such, the authoring device 120 may include, for example, a personal computer, laptop, server, blade, cloud device, tablet, or set top box. Various additional hardware devices for implementing the authoring device 120 will be apparent. The authoring device 120 may include multiple modules such as a simulator 122 configured to simulate anatomical structures and biological events, a simulation recorded 124 configured to create a video file based on the output of the simulator 122, and a simulation editor 126 configured to enable a user to edit video created by the simulation recorded 124.

The viewing device 130 may be any device capable of viewing presentation videos. As such, the viewing device 130 may include, for example, a personal computer, laptop, server, blade, cloud device, tablet, or set top box. Various additional hardware devices for implementing the viewing device 130 will be apparent. The viewing device 120 may include multiple modules such as a simulation viewer 132 configured to playback a video created by an authoring device 120. It will be apparent that this division of functionality may be different according to other embodiments. For example, in some embodiments, the viewing device 130 may alternatively or additionally include a simulation editor 126 or the authoring device 120 may include a simulation viewer 132.

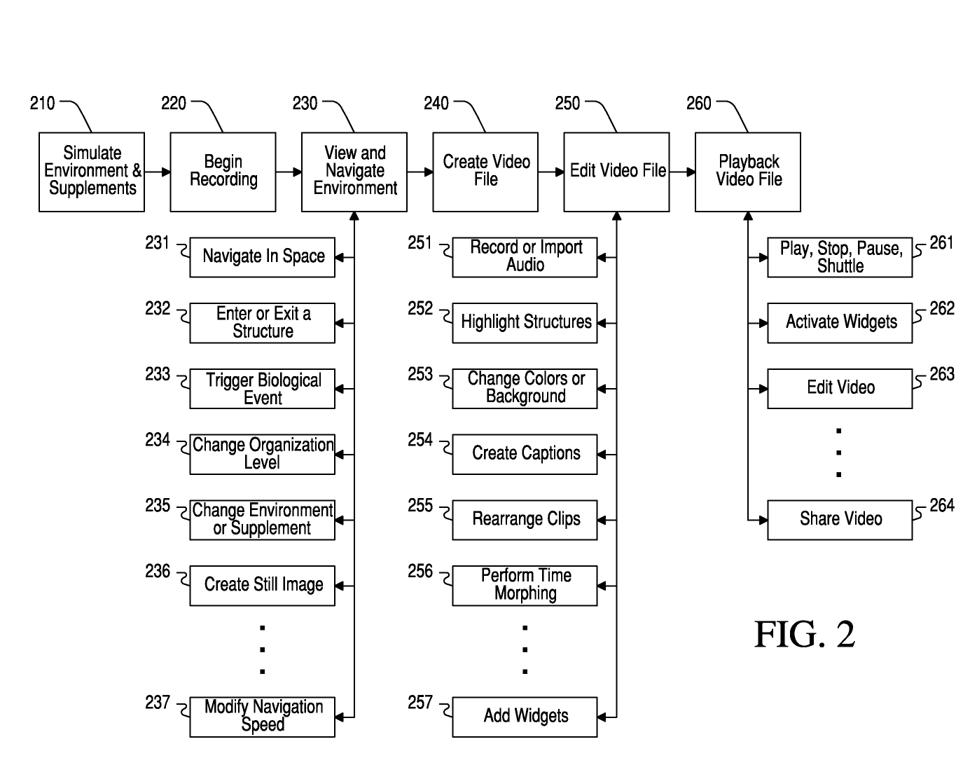

Having described the components of the exemplary system 100, a brief summary of the operation of the system 100 will be provided. It should be apparent that the following description is intended to provide an overview of the operation of system 100 and is therefore a simplification in some respects. The detailed operation of the system 100 will be described in further detail below in connection with FIGS. 2-15.

According to various exemplary embodiments, a user of the authoring device 120 may begin by selecting one or more environments and supplements stored on the backend server 110 to be used by the simulator 122 for simulating an anatomical structure or biological event. For example, the user may select an environment of a human heart and a supplement for simulating a malady such as, for example, a heart attack. After this selection, the backend server 110 may deliver 150 the data objects to the authoring device 120. The simulator 122 may load the data objects and begin the requested simulation. While simulating the anatomical structure or biological event, the simulator 122 may provide the user with the ability to modify the simulation by, for example, navigating in three dimensional space or activating biological events. The user may also specify that the simulation should be recorded via a user interface. After such specification, the simulation recorder 124 may capture image frames from the simulator 122 and create a video file. After the user has indicated that recording should cease, the simulation editor 126 may receive the video file from the simulation recorder 124. Then, using the simulation editor 126, the user may edit the video by, for example, rearranging clips or adding audio narration. After the user has finished editing the video, the authoring device 120 may upload 160 the video to be stored at the backend server 110. Thereafter, the viewing device 130 may download or stream 170 the video from the backend server for playback by the simulation viewer 132. As such, the viewing device may be able to replay the experience of the authoring device 120 user when originally interacting with the simulator 122.

It will be apparent that various other methods of distributing environments, supplements, or videos may be utilized. For example, in some embodiments, environments, supplements, or videos may be available for download from a third party provider, other than any party operating the exemplary system 100 or portion thereof. In other embodiments, environments, supplements, or videos may be distributed using a physical medium such as a DVD or flash memory device. Various other channels for data distribution will be apparent.

FIG. 2 illustrates an exemplary process flow 200 for creating and viewing presentations. As shown, the process flow may being in step 210 where an environment and one or more supplements are used to create an interactive simulation of an anatomical structure or biological event. In step 220, the user may specify that the simulation should be recorded. The user may then, in step 230, view and navigate the simulation. These interactions may be recorded to create a video for later playback. For example, the user may navigate in space 231, enter or exit a structure 232 (e.g., enter a chamber of a heart), trigger a biological event 233 (e.g., a heart attack or drug administration), change a currently viewed organization level 234 (e.g., from organ-level to cellular level such as by invoking a virtual microscope tool, as will be explained in greater detail below), change an environment or supplement 235 (e.g., switch from viewing a heart environment to a blood vessel environment), create a still image 236 of a current view, or modify a speed of navigation 237.

After the user has captured the desired simulation, the system may, in step 240, create a video file which may then be edited in step 250. For example, the user may record or import audio 251 to the video (e.g., audio narration), highlight structures 252 (e.g., change color of the aorta on the heart environment), change colors or background 253, create textual captions 254, rearrange clips 255, perform time morphing 256 (e.g., speed up or slow down playback of a specific clip), or add widgets 257 which enable a user viewing the video to activate a button or other object to affect playback by, for example, showing a nested video within the video file. After the user has finished editing the video, the video may be played back in step 260 to the user or another entity using a different device. In some embodiments, the user may be able to skip the editing step 250 entirely and proceed directly from the end of recording at step 240 to playback at step 260.

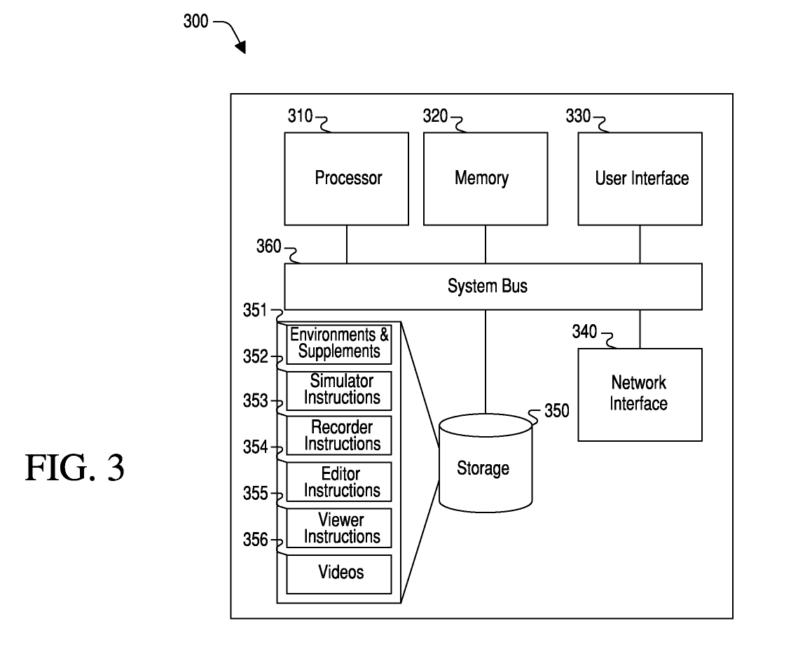

FIG. 3 illustrates an exemplary hardware device 300 for creating or viewing presentations. As such, the hardware device may correspond to the backend server 110, authoring device 120, or playback device 130 of the exemplary system. As shown, the hardware device 300 may include a processor 310, memory 320, user interface 330, network interface 340, and storage 350 interconnected via one or more system buses 360. It will be understood that FIG. 3 constitutes, in some respects, and abstraction and that the actual organization of the components of the hardware device 300 may be more complex than illustrated.

The processor 310 may be any hardware device capable of executing instructions stored in memory 320 or storage 350. As such, the processor may include a microprocessor, field programmable gate array (FPGA), application-specific integrated circuit (ASIC), or other similar devices.

The memory 320 may include various memories such as, for example L1, L2, or L3 cache or system memory. As such, the memory 320 may include static random access memory (SRAM), dynamic RAM (DRAM), flash memory, read only memory (ROM), or other similar memory devices.

The user interface 330 may include one or more devices for enabling communication with a user. For example, the user interface 330 may include a display and speakers for displaying video and audio to a user. As further examples, the user interface 330 may include a mouse and keyboard for receiving user commands and a microphone for receiving audio from the user.

The network interface 340 may include one or more devices for enabling communication with other hardware devices. For example, the network interface 340 may include a network interface card (NIC) configured to communicate according to the Ethernet protocol. Additionally, the network interface 240 may implement a TCP/IP stack for communication according to the TCP/IP protocols. Various alternative or additional hardware or configurations for the network interface 240 will be apparent.

The storage 350 may include one or more machine-readable storage media such as read-only memory (ROM), random-access memory (RAM), magnetic disk storage media, optical storage media, flash-memory devices, or similar storage media. In various embodiments, the storage 350 may store instructions for execution by the processor 310 or data upon with the processor 310 may operate. For example, the storage 350 may store various environments and supplements 351, simulator instructions 352, recorder instructions 353, editor instructions 354, viewer instructions 355, or videos 356. In various embodiments, the simulator instructions 352 may include instructions for rendering a microscope tool, as will be described in greater detail below. It will be apparent that the storage 350 may not store all items in this list and that the items actually stored may depend on the role taken by the hardware device. For example, where the hardware device 300 constitutes a viewing device 130, the storage 350 may not store any environments and supplements 351, simulator instructions 352, or recorder instructions 353. Various additional items and other combinations of items for storage will be apparent.

It will be understood that various items illustrated as being resident in the storage 350 may alternatively or additionally be stored in the memory 320. For example, the simulator instructions 352 may be copied to the memory 320 for execution by the processor 310. As such, the memory 320 may also constitute a storage medium. As used herein, the term “non-transitory machine-readable storage medium” will be understood to exclude a transitory propagation signal but to include all forms of volatile and non-volatile memory.

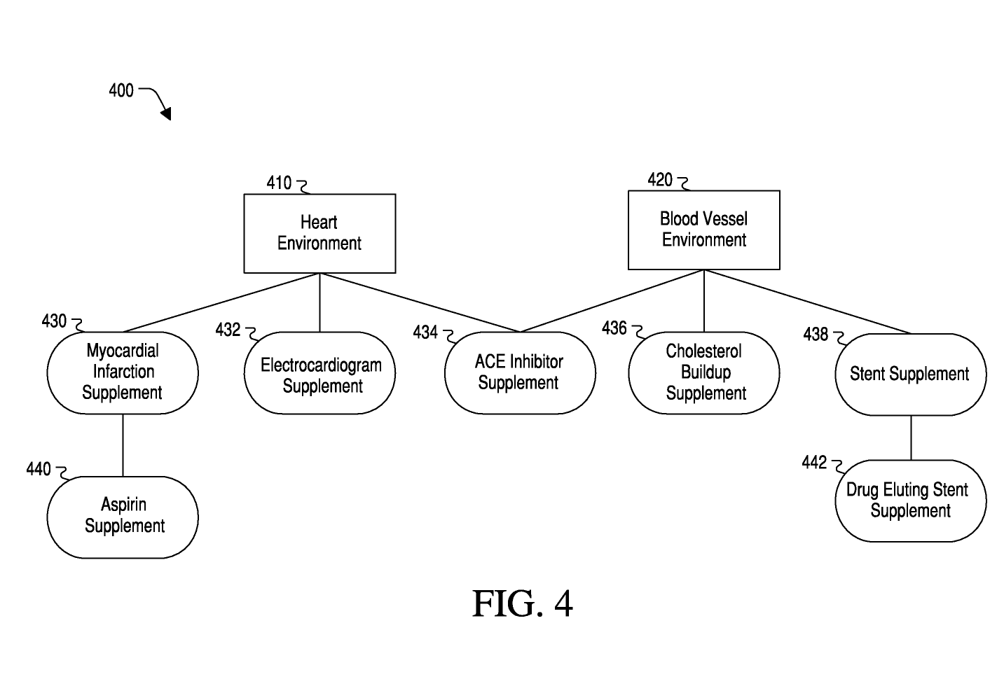

FIG. 4 illustrates an exemplary arrangement 400 of environments and supplements for use in creating presentations. As explained above, various systems, such as an authoring system 120 or, in come embodiments, a viewing device 130, may use environments or supplements to simulate anatomical structures or biological events. Environments may be objects that define basic functionality of an anatomical structure. As such, an environment may define a three-dimensional model for the structure, textures or coloring for the various surfaces of the three-dimensional model, and animations for the three-dimensional model. Additionally, an environment may define various functionality associated with the structure. For example, a heart environment may define functionality for simulating a biological function such as a heart beat or a blood vessel environment may define functionality for simulating a biological function such as blood flow. In various embodiments, environments may be implemented as classes or other data structures that include data sufficient for defining the shape and look of an anatomical structure and functions sufficient to simulate biological events and update the shape and look of the anatomical structure accordingly. In some such embodiments, the environments may implement “update” and “draw” methods to be invoked by methods of a game or other rendering engine.

Supplements may be objects that extend functionality of environments or other supplements. For example, supplements may extend a heart environment to simulate a heart attack or may extend a blood vessel environment to simulate the implantation of a stent. In various embodiments, supplements may be classes or other data structures that extend or otherwise inherit from other objects, such as environments or other supplements, and define additional functions that simulate additional biological events and update the shape and look of an anatomical structure (as defined by an underlying object or by the supplement itself) accordingly. In some embodiments, a supplement may carry additional three-dimensional models for rendering additional items such as, for example, a surgical device or a tumor. In some such embodiments, a supplement may implement “update” and “draw” methods to be invoked by methods of a game or other rendering engine. In some cases, the update and draw methods may override and themselves invoke similar methods implemented by underlying objects.

Exemplary arrangement 400 includes two exemplary environments: a heart environment 410 and a blood vessel environment 420. The heart environment 410 may be an object that carries a three-dimensional model of a heart and instructions sufficient to render the three-dimensional model and to simulate some biological functions. For example, the instructions may simulate a heart beat. Likewise, the blood vessel environment 420 may be an object that carries a three-dimensional model of a blood vessel and instructions sufficient to render the three-dimensional model and to simulate some biological functions. For example, the instructions may simulate blood flow. As described above, the heart environment 410 and blood vessel environment 420 may be implemented as classes or other data structures which may, in turn, extend or otherwise inherit from a base environment class.

The arrangement 400 may also include multiple supplements 430-442. The supplements 430-442 may be objects, such as classes or other data structures, that define additional functionality in relation to an underlying model 410, 420. For example, a myocardial infarction supplement 430 and an electrocardiogram supplement 432 may both extend the functionality of the heart environment 410. The myocardial infarction supplement 430 may include instructions for simulating a heart attack on the three dimensional model defined by the heart environment 410. The myocardial infarction supplement 430 may also include instructions for displaying a button or otherwise receiving user input toggling the heart attack simulation. The electrocardiogram (EKG) supplement 432 may include instructions for simulating an EKG device. For example, the instructions may display a graphic of an EKG monitor next to the three dimensional model of the heart. The instructions may also display an EKG output based on simulated electrical activity in the heart. For example, as part of the simulation of a heart beat or heart attack, the heart environment 410 or myocardial infarction supplement 430 may generate simulated electrical currents which may be read by the EKG supplement 432. Alternative methods for simulating an EKG readout will be apparent.

Some supplements may extend the functionality of multiple environments. For example, the ACE inhibitor supplement 434 may include extended functionality for both the heart environment 410 and the blood vessel environment 420 to simulate the effects of administering an ACE inhibitor medication. In some embodiments, the ACE inhibitor supplement 410 may actually extend or otherwise inherit from an underlying base environment class from which the heart environment 410 and blood vessel 420 may inherit. Further, the ACE inhibitor supplement 434 may define separate functionality for the different environments 410, 420 from which it may inherit or may implement the same functionality for use by both environments 410, 420, by relying on commonalities of implementation. For example, in embodiments wherein both the heart environment 410 and blood vessel environment 420 are implemented to simulate biological events based on a measure of angiotensin-converting-enzyme or blood vessel dilation, activation of the ACE inhibitor functionality may reduce such a measure, thereby affecting the simulation of the biological event.

As further examples, a cholesterol buildup supplement 436 and a stent supplement 438 may extend the functionality of the blood vessel environment 420. The cholesterol buildup supplement 436 may include one or more three dimensional models configured to render a buildup of cholesterol in a blood vessel. The cholesterol buildup supplement 436 may also include instructions for simulating the gradual build up the cholesterol on the blood vessel wall, colliding with other matter such as blood clots, and receiving user input to toggle or otherwise control the described functionality. The stent supplement 438 may include one or more three dimensional models configured to render a surgical stent device. The stent supplement 438 may also include instructions for simulating a weakened blood vessel wall, simulating the stent supporting the blood vessel wall, and receiving user input to toggle or otherwise control the described functionality.

Some supplements may extend the functionality of other supplements. For example, the heart attack aspirin supplement 440 may extend the functionality of the myocardial infarction supplement 430 by, for example, providing instructions for receiving user input to administer aspirin and instructions for simulating the effect of aspirin on a heart attack. For example, in some embodiments, the instructions for simulating a heart attack carried by the myocardial infarction supplement 430 may utilize a value representing blood viscosity while the aspirin supplement may include instructions for reducing this blood viscosity value. As another example, the drug eluting stent supplement 442 may extend the functionality of the stent supplement by providing instructions for simulating drug delivery via a stent, as represented by the stent supplement 442. These instructions may simulate delivery of a specific drug or may illustrate drug delivery via drug eluting stent generally.

It will be apparent that the functionality described in connection with the environments and supplements of arrangement 400 are merely exemplary and that virtually any anatomical structure or biological event (e.g., natural functions, maladies, drug administration, device implant, or surgical procedures) may be implemented using an environment or supplement. Further, alternative or additional functionality may be implemented with respect to any of the exemplary environments or supplements described.

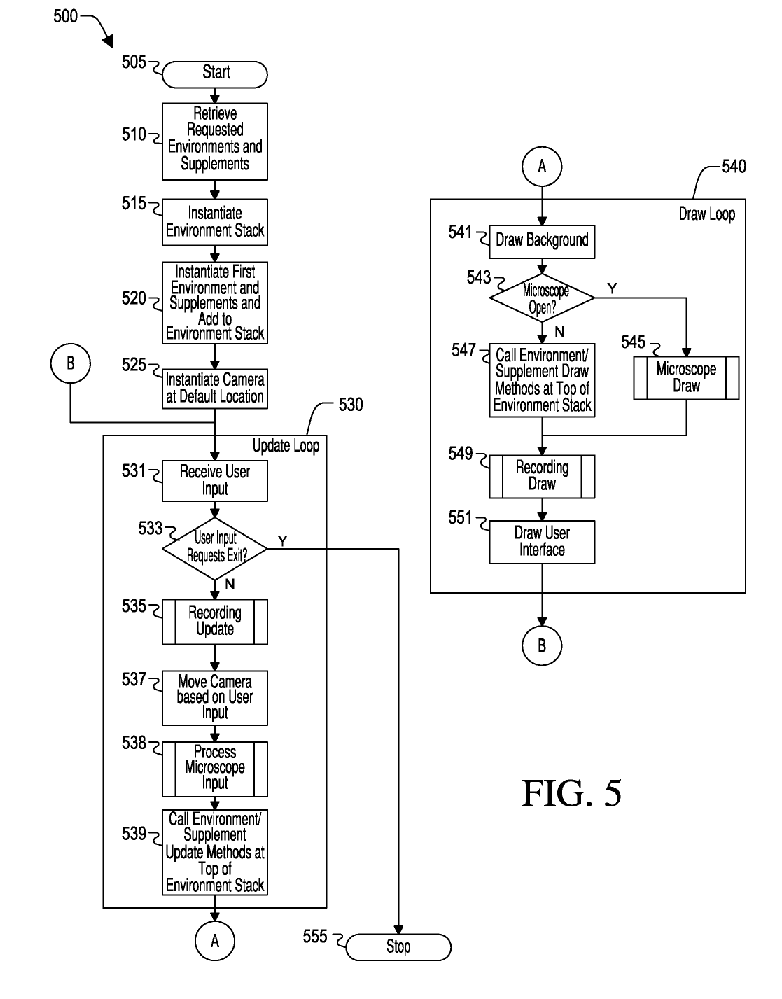

FIG. 5 illustrates an exemplary method 500 for recording user interaction with environments and supplements. Method 500 may be performed by the components of a device such as, for example, the simulator 122 and simulation recorder 124 of the authoring device 120 of system 100. Various other device for executing method 500 will be apparent such as, for example, the viewing device 130 in embodiments where the viewing device 130 includes a simulator 122 or simulation recorder 124.

The method 500 may begin in step 505 and proceed to step 510 where the device may retrieve any environments or supplements requested by a user. For example, where the user has requested the simulation of a heart attack, the system may retrieve a heart environment and myocardial infarction supplement for use. This retrieval may include retrieving one or more of the data objects from a local storage or cache or from a backend server that provides access to a library of environments or supplements. Next, in step 515, the device may instantiate an environment stack data structure for use in tracking multiple environments. For example, when a microscope tool is activated, the stack may be used to store the original environment (e.g., the environment being “maginified”) and the new environment (e.g., the environment simulating the “magnified” image). It will be apparent that various alternative data structures may be used other than a stack such as, for example, an array or two separate environment variables.

After instantiating the environment stack, the device may, in step 520, instantiate the retrieved environments or supplements and add them to the stack. For example, the device may create an instance based on the class defining a myocardial infarction supplement and, in doing so, create an instance of the class defining a heart environment. Then, the myocardial infarction instance is added to the environment stack. Next, in step 525 the device may instantiate one or more cameras at a default location and with other default parameters. As will be readily understood and explained in greater detail below, the term “camera” will be understood to refer to an object based on which images or video may be created. The camera may define a position in three-dimensional space, an orientation, a zoom level, and other parameters for use in rendering a scene based on an environment or supplement. In various embodiments, default camera parameters may be provided by an environment or supplement.

Next, the device may proceed to loop through the update loop 530 and draw loop 540 to simulate and render the anatomical structures or biological events. As will be understood, the update loop 530 may generally perform functions such as, for example, receiving user input, updating environments and supplements according to the user input, simulating various biological events, and any other functions that do not specifically involve rendering images or video for display. The draw loop 540, on the other hand, may perform functions specifically related to displaying images or video such as rendering environments and supplements, rendering user interface elements, and exporting video. In various embodiments, an underlying engine may determine when and how often the update loop 530 and draw loop 540 should be called. For example, the engine may call the update loop 530 more often than the draw loop 540. Further, the ratio between update and draw calls may be managed by the engine based on a current system load. In some embodiments, the update and draw loops may not be performed fully sequentially and, instead, may be executed, at least partially, as different threads on different processors or processor cores. Various additional modifications for implementing an update loop 530 and a draw loop 540 will be apparent.

The update loop 530 may begin with the device receiving user input in step 531. In various embodiments, step 531 may involve the device polling user interface peripherals such as a keyboard, mouse, touchscreen, or microphone for new input data. The device may store this input data for later use by the update loop 530. Next, in step 533, the device may determine whether the user input requests exiting the program. For example, the user input may include a user pressing the Escape key or clicking on an “Exit” user interface element. If the user input requests exit, the method 500 may proceed to end in step 555. Step 555 may also include an indication to an engine that the program should be stopped.

If, however, the user input does not request program exit, the method 500 may proceed to step 535 where the device may perform one or more update actions specifically associated with recording video. Exemplary actions for performance as part of step 535 will be described in greater detail below with respect to FIG. 8. Next, in step 537, the device may “move” the camera object based on user inputs. For example, if the user has pressed the “W” key or the “Up Arrow” key, the device may “move the camera forward” by updating a position parameter of the camera based on the current orientation. As another example, if the user has moved the mouse laterally while holding down the right mouse button, the device may “rotate” the camera by updating the orientation parameter of the camera. Various alternative or additional methods for modifying the camera based on user input will be apparent. Further, in some embodiments wherein multiple cameras are maintained, step 537 may involve moving such multiple cameras together based on the user input.

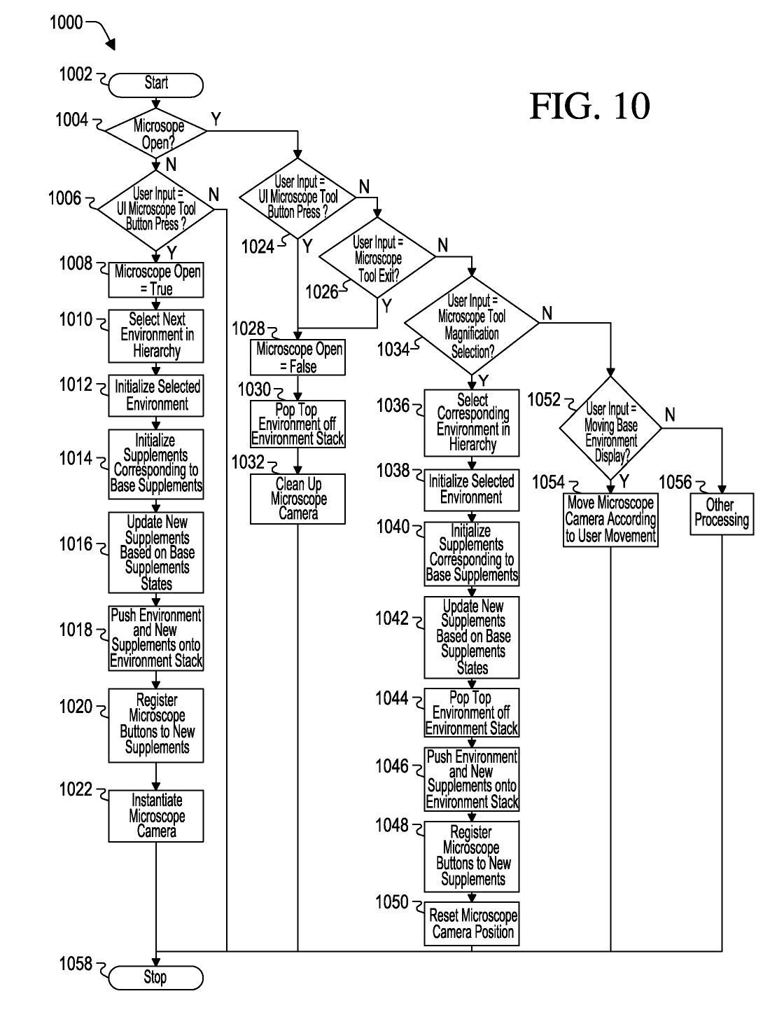

In step 538, the device may process one or more inputs specifically related to a virtual microscope tool. For example, the device may, in response to user input, toggle the virtual microscope tool on or off, change a magnification level, move a camera within the microscope, administer medication, apply a stain or slide treatment, activate another supplement, or perform some other modification to the underlying environment simulations. An exemplary method for processing microscope input will be described in greater detail below with respect to FIG. 10.

Next, in step 539, the device may invoke update methods of any top level environments or supplements on the top of the stack (or otherwise indicated as a primary environment underlying a microscope or other tool). These update methods, defined by the environments or supplements themselves, may implement the simulation and interactivity functionality associated with those environments and supplements. For example, the update method of the heart environment may update the animation or expansion of the three dimensional heart environment in accordance with the heartbeat cycle. As another example, the myocardial infarction supplement may read user input to determine whether the user has requested that heart attack simulation begin. Various additional functions for implementation in the update methods of the environments and supplements will be apparent.

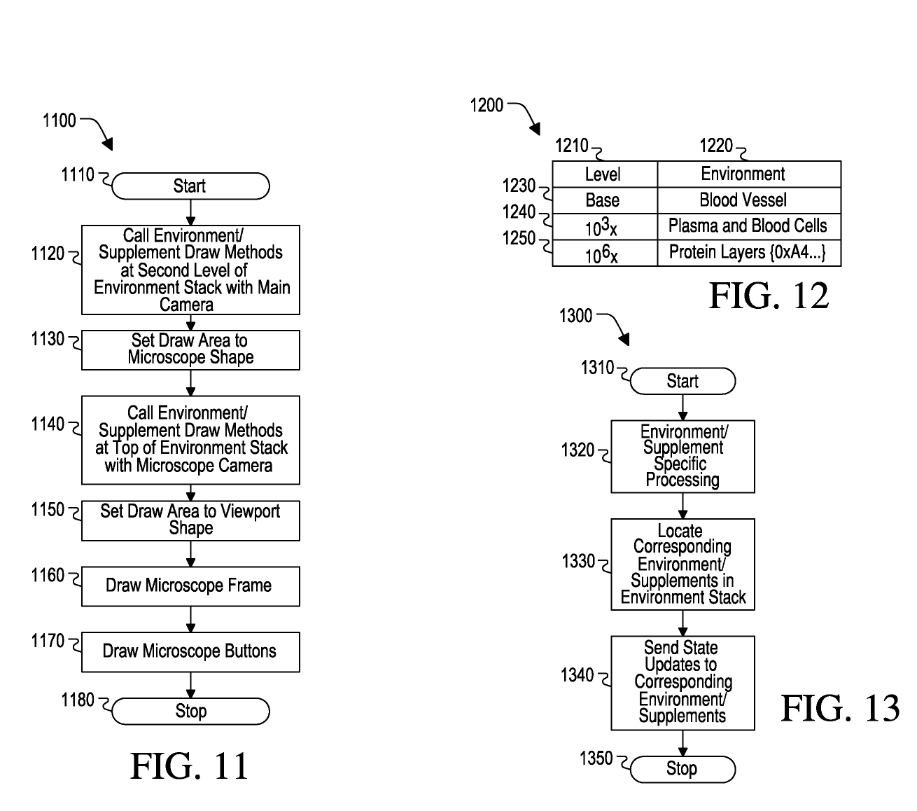

The update loop 530 may then end and the method 500 may proceed to the draw loop 540. The draw loop 540 may begin in step 541 where the device may “draw” the background to the graphics device. In various embodiments, drawing may involve transferring color, image, or video data to a graphics device for display. To draw a background, the device may set the entire display to display a particular color or may transfer a background image to a buffer of the graphics device. Then, in step 543, the device may determine whether the virtual microscope tool is currently open by, for example, reading a flag or Boolean value that is set based on toggling the microscope display. If the microscope is open, the device may proceed to step 545 where specific steps for drawing the microscope tool are taken. An exemplary method for drawing a microscope tool will be described in greater detail below with respect to FIG. 11.

If, on the other hand, the microscope is not open the method 500 may proceed to step 547 where the device may call the respective draw methods of any top level environments or supplements. These respective draw methods may render the various anatomical structures and biological events represented by the respective environments and supplements. Further, the draw methods may make use of the camera, as most recently updated during the update loop 530. For example, the draw method of the heart environment may generate an image of the three dimensional heart model from the point of view of the camera and output the image to a buffer of a display device. It will be understood that, in this way, the user input requesting navigation may be translated into correspondingly updated imagery through operation of both the update loop 530 and draw loop 540.

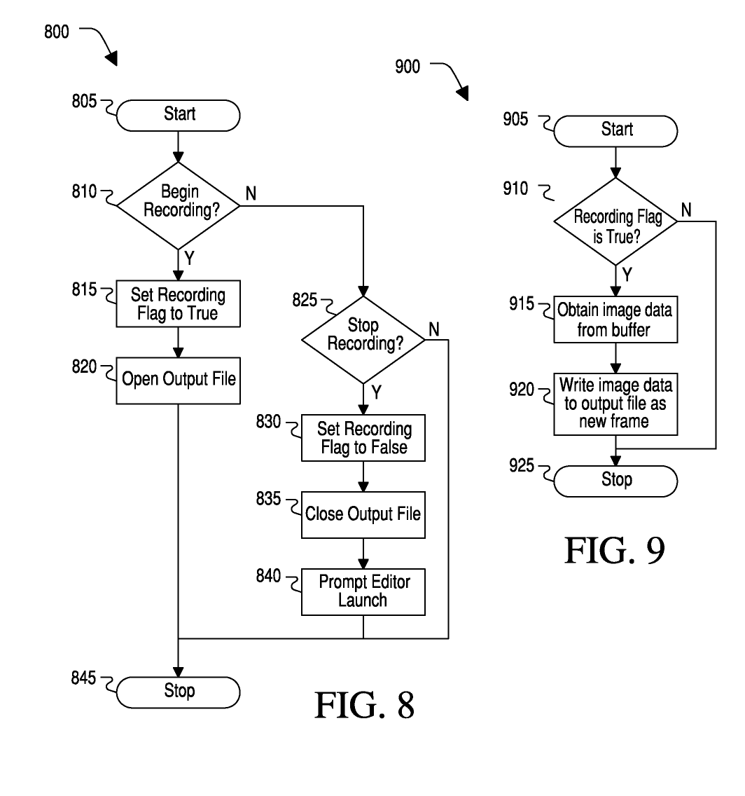

Next, in step 549, the device may perform one or more draw functions relating to recording a video file. Exemplary functions for drawing to a video file will be described in greater detail below with respect to FIG. 9. Then, in step 551, the device may draw any user interface elements to the screen. For example, the device may draw a record button, an exit button, or any other user interface elements to the screen. The method 500 may then loop back to the update loop 530.

It will be understood that various modifications to the draw loop are possible for effecting variations in the output images or video. For example, step 549 may be moved after step 551 so that the user interface is also captured. Various other modifications will be apparent.

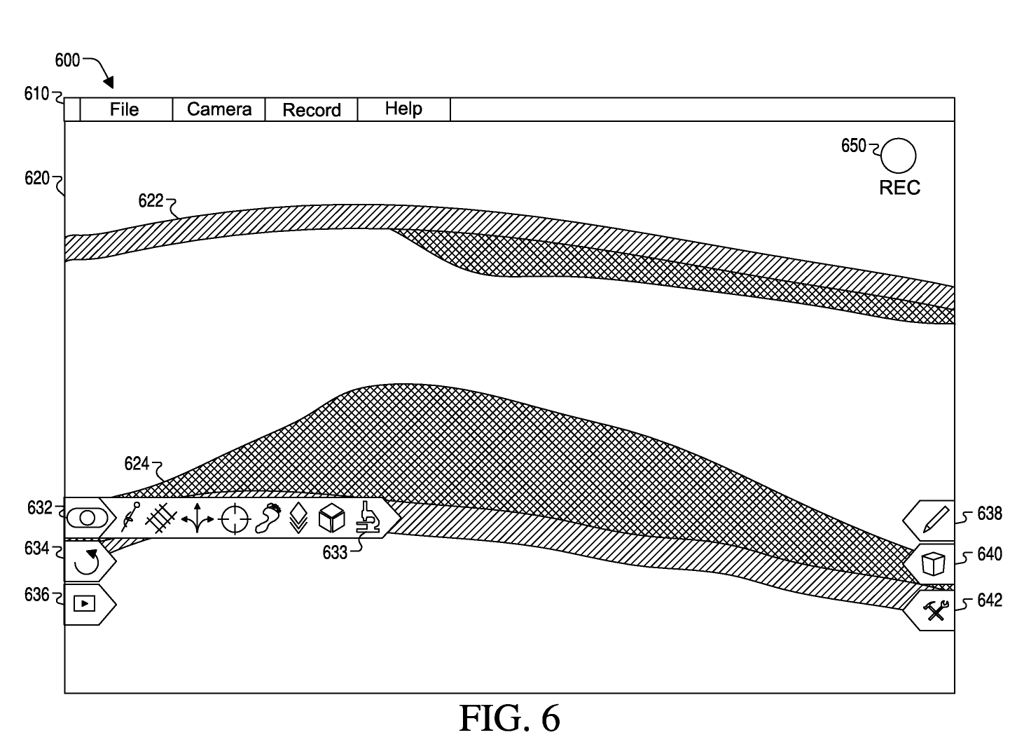

FIG. 6 illustrates an exemplary GUI 600 for recording interaction with environments and supplements. The GUI 600 may be used by the user to navigate an anatomical structure, trigger and observe a biological event, or record the user's experience. As shown, the GUI 600 may include a toolbar 610 and a viewing field 620. The toolbar may provide access to various functionality such as exiting the program, receiving help, activating a record feature, or modifying a camera to alter a scene. Various other functionality to expose via the toolbar 610 will be apparent.

The viewing field 620 may display the output of a draw loop such as the draw loop 540 of method 500. As such, the viewing field 620 may display a representation of an environment including various structures associated with an environment or supplement. The exemplary viewing field 620 of FIG. 6 may display a representation of a “blood vessel with cholesterol buildup” environment including a blood vessel wall 622 and plaque buildup 624. The representation may be animated based on an underlying simulation. For example, the representation may animate flowing blood with suspended plaque and gradual buildup of the plaque 624. Various alternative environments and underlying simulations will be apparent in view of the foregoing.

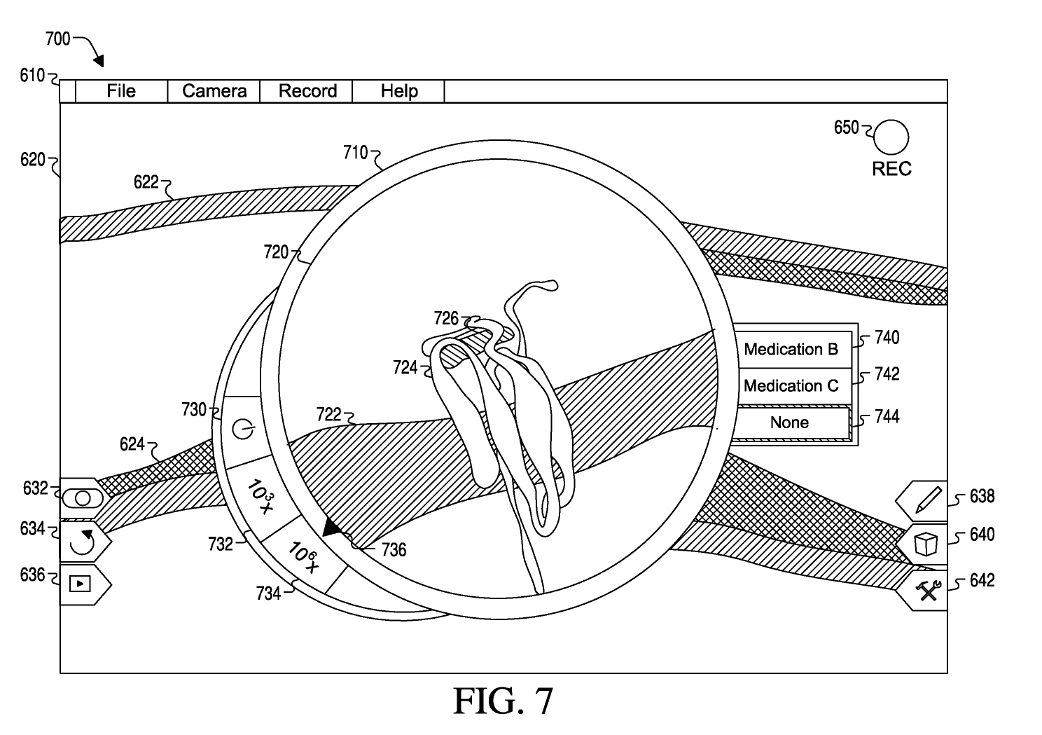

The viewing field 620 may include multiple overlaid GUI elements such as buttons 632, 634, 636, 638, 640, 642 for allowing the user to interact with the simulation. It will be apparent that other methods for allowing user interaction may be implemented. For example, touchscreen or mouse input near the plaque buildup 624 may enable the user to relocate or change the volume of the plaque buildup 624. The buttons 632, 634-642 may enable various functionality such as modifying the camera, undoing a previous action, exporting a recorded video to the editor, annotating portions of the scene, deleting recorded video, or changing various settings. Further, various buttons may provide access to additional buttons or other GUI elements. For example, the button 732 providing access to camera manipulations may, upon selection, display a submenu that provides access to camera functionality such as a) “pin spin,” enabling the camera to revolve around a user-selected point, b) “camera rail,” enabling the camera to travel along a predefined path, c) “free roam,” allowing a user to control the camera in three dimensions, d) “aim assist,” enabling the camera's orientation to track a selected object as the camera moves, e) “walk surface,” enabling the user to navigate as if walking on the surface of a structure, f) “float surface,” enabling the user to navigate as if floating above the surface of a structure, or g) “holocam,” toggling holographic rendering. Another sub-button 633 may enable the launch or display toggle of a virtual microscope tool, as will be described in greater detail below with respect to FIG. 7. It will be understood that the microscope button 633 may be located elsewhere, such as on the UI as a button similar to buttons 632, 634-642, and that the virtual microscope may be accessed by alternative methods, such as via selection of an item within the toolbar 610.

The GUI 600 may also include a button or indication 650 showing whether video is currently being recorded. The button or indication 650 may also be selectable to toggle recording of video. In some embodiments, the user may be able to begin and start recording multiple times to generate multiple independent video clips for later use by the editor.

FIG. 7 illustrates an exemplary GUI 700 for displaying and recording a microscope tool. The GUI 700 may be a future state of the GUI 600 of FIG. 6 after launch of a microscope tool. As such, the GUI 700 may include many of the same elements as the GUI 600 such as the toolbar 610, UI elements 632-650, and representation of the original environment (e.g., the blood vessel with cholesterol buildup environment) in viewing field 620.

The GUI 700 also includes a microscope frame 710, inside which a second viewing field 720 displays a representation of a second environment. In the example shown, the second viewing field 720 may show a “magnified” image of the underlying blood vessel environment by displaying a representation of a protein layer environment to simulate a 1,000,000× magnification of the blood vessel. As such, the secondary viewing field 720 may illustrate a membrane 722 and a transmembrane protein 724 binding with a free-floating protein 726. Various alternative magnified environments will be apparent. Because the GUI 700 includes multiple representations of different environments, the GUI 700 may be referred to as including a “compound representation.”

In some embodiments, the microscope frame 710 (or other portal frame in non-microscope contexts) may be as little as a border around the secondary viewport 720. As illustrate, the microscope frame 710 include additional UI elements including a “power off” button 730 for exiting the microscope tool, magnification buttons 732, 734 for switching the magnification level represented in the secondary viewing field 720, an indicator 736 for indicating the currently selected magnification level, and a tool palette including multiple tool buttons 740, 742 for effecting a modification to the environment shown in the secondary viewport 720 and a tool button 744 for the removal of any such modification. For example, as shown, the buttons 740, 742 may indicate that the administration of a medication should be simulated in the environment shown in the secondary viewport 720. In various embodiments, this state change may also be shared with other environments. For example, the effects of the medication may also be simulated in the environment shown in the primary viewing field 620. Various other modifications may be effected via a button in the tool palette such as the induction of a disease, stain or slide treatment, any other type of effect that may be available on any type of microscope, or other modifications as will be apparent in view of this specification. Further, it will be apparent that different buttons may be used in place of or in addition to the magnification buttons 732, 734. For example, buttons may be used to request an “x-ray” view, a “cutaway” view, any other analogy for viewing a different environment, or for viewing a different environment without the pretext of a tool analogy.

The secondary viewing field 720 may also enable navigation of the secondary environment. For example, with the viewing field 720 or microscope frame 710 selected, the user may be able to navigate the secondary environment (e.g., the protein layers environment, as illustrated) using arrow keys, WASD keys, or other means for three dimensional magnification. Alternatively or additionally, the user may be able to click and drag the microscope frame around the GUI 700 and across the viewing field 620 to move the camera associated with the environment displayed in the secondary viewing field 720, thereby simulating a movement of a microscope with respect to the underlying imagery. Alternatively or additionally, the user may be able to click and drag the underlying imagery of the viewing field 620 to move the camera associated with the environment displayed in the secondary viewing field 720, thereby simulating movement of a slide or other object being magnified underneath the microscope.

FIG. 8 illustrates an exemplary method 800 for toggling recording mode for environments and supplements. In various embodiments, the method 800 may correspond to the recording update step 535 of the method 500. The method 800 may be performed by the components of a device, such as the authoring device 120 of exemplary system 100.

The method 800 may begin in step 805 and proceed to step 810 where the device may determine whether the device should begin recording video. For example, the device may determine whether the user input includes an indication that the user wishes to record video such as, for example, a selection of the record indication 650 or another GUI element 610, 632-644 on GUI 600 or GUI 700. In various embodiments, the input may request a toggle of recording status; in such embodiments, the step 810 may also determine whether the current state of the device is not recording by accessing a previously-set “recording flag.” If the device is to begin recording, the method 800 may proceed to step 815, where the device may set the recording flag to “true.” Then, in step 820, the device may open an output file to receive the video data. Step 820 may include establishing a new output file or opening a previously-established output file and setting the write pointer to an empty spot and or layer for receiving the video data without overwriting previously-recorded data. The method 800 may then end in step 845 and the device may resume method 500.

If, on the other hand, the device determines in step 810 that it should not begin recording, the method 800 may proceed to step 825 where the device may determine whether it should cease recording video. For example, the device may determine whether the user input includes an indication that the user wishes to stop recording video such as, for example, a selection of the record indication 650 or another GUI element 610, 632-644 on GUI 600 or GUI 700. In various embodiments, the input may request a toggle of recording status; in such embodiments, the step 825 may also determine whether the current state of the device is recording by accessing the recording flag. If the device is to stop recording, then the method 800 may proceed to step 830 where the device may set the recording flag to “false.” Then, in step 835, the device may close the output file by releasing any pointers to the previously-opened file. In some embodiments, the device may not perform step 835 and, instead, may keep the file open for later resumption of recording to avoid unnecessary duplication of steps 820 and 835. After stopping recording in steps 830, 835, the device may prompt the user in step 840 to open the video editor to further refine the captured video file. For example, the device may display a dialog box with a button that, upon selection, may close the simulator or recorder and launch the editor. The method 800 may then proceed to end in step 845. If, in step 825, the device determines that the device is not to stop recording, the method 800 may proceed directly to end in step 845, thereby effecting no change to the recording status.

FIG. 9 illustrates an exemplary method 900 for outputting image data to a video file. In various embodiments, the method 900 may correspond to the recording draw step 549 of the method 500. The method 900 may be performed by the components of a device, such as the authoring device 120 of exemplary system 100.

The method 900 may begin in step 905 and proceed to step 910 where the device may determine whether video data should be recorded by determining whether the recording flag is currently set to “true.” If the recording flag is not “true,” then the method may proceed to end in step 925, whereupon method 500 may resume execution. Otherwise, the method 900 may proceed to step 915, where the device may obtain image data currently stored in an image buffer. As such, the device may capture the display device output, as currently rendered at the current progress through the draw loop 540. Various alternative methods for capturing image data will be apparent. Next, in step 920, the device may write the image data to the currently-open output file. Writing the image data may entail writing the image data at a current write position of a current layer of the output file and then advancing the write pointer to the next empty location or frame of the output file. In some embodiments, the device may also capture audio data from a microphone of the device and output the audio data to the output file as well.

FIG. 10 illustrates an exemplary method 1000 for processing microscope tool input. The method 1000 may correspond to step 538 of the main program loop method 500. And may be performed, for example, by the components of an authoring device 120 or another device. It will be apparent that various alternative methods may be used for processing inputs such as, for example, the use of event handlers associated with each UI element or mapped keyboard key.

The method 1000 begins in step 1002 and proceed to step 1004 where the device determines whether the microscope is currently open. For example, the device may read a “Microscope Open” variable indicating whether the microscope is currently open. If the microscope is not open, the method proceeds to step 1006 to determine whether the user input requests that the microscope be opened. For example, the device may determine whether a microscope UI button, such as button 633 has been pressed. If not, the method 1000 proceeds to end in step 1058. As such, according to the exemplary method 1000, the only microscope-related input to be processed when the microscope is closed is a request to open the microscope. Various alternative configurations will be apparent.

If, on the other hand, the device determines in step 1006 that the user input does request that the microscope be opened, the method proceeds to step 1008 where the device sets the “Microscope Open” variable to “true,” such that future iterations of the method 1000 will be aware that the microscope is open at step 1004. Next, in step 1010, the device may select a new environment to open within the microscope. For example, the button selected by the user may be associated with a specific secondary environment, the device may locate the last environment displayed within the microscope tool, or the device may select an environment from a hierarchy associated with the primary environment. An exemplary environment hierarchy will be described in greater detail below with respect to FIG. 12.

After selecting an environment, the device proceeds to initialize the environment in step 1012 and any supplements corresponding to supplements instantiated for the base environment in step 1014. For example, where the primary environment is a “blood vessel with cholesterol buildup” environment, the device may instantiate the protein layer environment with one or more supplements to simulate cholesterol at a protein level. In step 1016, the device may update the newly-initialized supplements based on the states of the base supplements in the primary environment. For example, if the user, prior to invoking the microscope tool, had changed the state of the cholesterol supplement by administering a drug or if simulation of the supplement itself has brought the supplement to a new state, that state may be translated to the context of the new supplement.

In step 1018, the device pushes the new environment and supplements onto the environment stack. It will be appreciated that by pushing the environment onto the top of the environment stack, the device will begin performing environment update procedures for the new environment automatically by virtue of step 539 of the main loop method 500 calling update methods for the environment at the top of the stack. In various embodiments, step 539 may also call update methods for environments further down the stack, such that, for example, the simulation and animation of the primary environment continues while the microscope tool is open.

In step 1020, the device may register tool palette buttons (e.g., buttons 740-744) to the newly-established supplements such that the supplements may be activated. For example, the device may establish new or activate preexisting event handlers tied to an ID of the buttons. The device may also enable visibility of the newly-registered buttons such that the draw loop renders the buttons. Then, the device instantiates a microscope camera for use in rendering the secondary environment representation to be displayed within the microscope frame. The method 1000 then proceeds to end in step 1058.

If, on the other hand, the microscope tool is open in step 1004, additional inputs may be available for the user with regard to the microscope. First, the device checks whether the user has requested the closure of the microscope tool by determining whether the user pressed the UI microscope button 633 or the microscope exit button 730 in steps 1024 and 1026, respectively. Various alternative methods for receiving instruction to close a microscope tool will be apparent. If the user input indicates that the microscope tool should be closed, the method 1000 proceeds to step 1028 where the device sets the “Microscope Tool” variable to “false.” Next, in step 1030, the device pops the top environment off the environment stack such that the primary environment (or otherwise “next” environment down” is now on the top of the stack for simulation in step 539 of the main loop method 500. The device then performs cleanup procedures in step 1032 by, for example, releasing resources associated with the microscope camera, secondary environment, etc. The method 1000 then proceeds to end in step 1058.

If the user does not request exit from the microscope tool, the device may determine, in step 1034, where the user input requests a different environment be displayed within the microscope frame. For example, the device may determine whether the user has pressed a magnification button 732, 734. If so, the method proceeds to step 1036 where the device selects a environment corresponding to the selected magnification level within the hierarchy for the primary environment. For example, in the context of FIG. 7, if the button pressed is the “1000×” button 732, the device may locate a hierarchy defined for the “blood vessel” or “blood vessel with cholesterol buildup” environment, and locate a record within the hierarchy associated with the “1000×” magnification level, and then read the environment along any supplements or parameters from the record. Then, in step 1038, the device proceeds to initialize the environment and any supplements corresponding to supplements instantiated for the base environment in step 1040. In step 1042, the device may update the newly-initialized supplements based on the states of the base supplements in the primary environment.

In step 1044, the device pops the top environment (e.g., the environment currently displayed in the microscope frame) off of the environment stack. Then, in step 1046, the device pushes the new environment and supplements onto the environment stack. It will be appreciated that by pushing the environment onto the top of the environment stack, the device will begin performing environment update procedures for the new environment automatically by virtue of step 539 of the main loop method 500 calling update methods for the environment at the top of the stack.

If, on the other hand, the user input does not request that the environment be changed, the method 1000 proceeds to step 1052, where the device determines where the user input requests movement of the camera within the secondary environment. For example, the user input may include a click and drag of the representation of the primary environment or of the microscope frame. Alternatively, the user input may include a keypress on the user's keyboard. If the user input does request camera movement, the device may move the microscope camera according to the user movement of the base environment display, microscope frame, or other user input in step 1054. As such, future iterations of the draw loop 540 of the main loop method 500 will render the secondary scene from the point of view of the updated camera position. The method may then proceed to end in step 1058.

If the user input does not request camera movement, the method 1000 proceeds to step 1056 where the device performs other processing. For example, the device may process a press of a tool palette button such as exemplary buttons 740-744 by activating or deactivating one or more supplements such as medications or diseases or by activating or deactivating microscope specific effects such as stains and slide treatments. Various alternative and additional microscope tool specific update processing will be apparent. The method then proceeds to end in step 1058.

FIG. 11 illustrates an exemplary method 1100 for drawing a microscope tool. The method 1100 may correspond to step 545 of the main program loop method 500. And may be performed, for example, by the components of an authoring device 120 or another device. It will be apparent that various alternative methods may be used for drawing the GUI.

The method 1100 begins in step 1110 and proceeds to step 1120 where the device calls any draw methods for the environment and supplements at the second layer of the environment stack using the main camera. In other words, the device calls the methods to draw the representation of the primary environment from the point of view of the main camera. Next, in step 1130, the device sets the draw area to the microscope shape (e.g., a circle located where the microscope tool is to appear) such that subsequent drawing may only occur in the new draw area. Then, in step 1140, the device calls any draw methods for the environment and supplements at the top layer of the environment stack using the microscope camera. In other words, the device calls the methods to draw the representation of the secondary environment from the point of view of the microscope camera. Because the draw area was previously restricted, the drawing occurs only within the area selected for the microscope tool, leaving the imagery associated with the primary environment outside of the draw area unaltered but overwriting any image data within the draw area. Next, in step 1150, the device resets the draw area to the viewport shape such that image data may be define anywhere in the screen. Then, in steps 1160 and 1170 the device draws the microscope frame and enabled/visible buttons, respectively. These steps may include copying one or more prerendered textures defining the frame and buttons to the image buffer. The method 1100 then proceeds to end in step 1180.

FIG. 12 illustrates an exemplary data arrangement 1200 for storing environment associations. It will be apparent that the data arrangement 1200 may be stored in any appropriate manner such as, for example, a table or linked list. The data arrangement may be stored in a storage or memory of the device for use by the microscope update method 1000 or another portal updated method. As shown, the data arrangement stores a magnification hierarchy; it will be understood that similar associations between environments may be similarly represented.

The data arrangement 1200 includes a level field 1210 for storing an indication of the magnification level associated with a hierarchy record and an environment field 1220 for storing an identification of an environment and any supplements or parameters to be loaded when the hierarchy level is selected.

As shown, the first record 1230 relates to a base or 1× magnification level and is associated with the blood vessel environment. As such, the data arrangement 1200 may be applicable when the blood vessel environment is instantiated as the primary environment. The next record 1240 relates to the 1000× magnification level and indicates that, when the 1000× magnification is selected on a microscope tool established over the blood vessel environment, the microscope tool should represent that “plasma and blood cells” environment as the secondary environment. Likewise, the record 1250 relates to the 1000000× magnification level and indicates that, when the 1000000× magnification is selected on a microscope tool established over the blood vessel environment, the microscope tool should represent that “protein layers” environment as the secondary environment. This record 1250 includes additional parameters “0xA4 . . . ” for use in establishing an appropriate “protein layers” environment. For example, the additional parameters may indicate one or more structures (such as specific proteins) to be added to the environment to accurately simulate the magnification of the underlying blood vessel. Various additional modifications will be apparent.

FIG. 13 illustrates an exemplary method for sharing state information between environments. In various embodiments, the method 1300 may be implemented in various environment and supplement update functions to enable state sharing. For example, a supplement for administering a medication at the protein layer level may implement this function to enable triggering a supplement for administering the medication at the blood vessel level or for otherwise modifying the blood vessel level environment or supplements consistent with administration of the medication.

The method 1310 begins in step 1310 and proceeds to step 1320 where the environment or supplement performs any processing specific to the environment or supplement. For example, a blood vessel environment may simulate blood flow or a cholesterol buildup supplement may simulate addition of plaque to the blood vessel wall. Next, in step 1330, the environment or supplement may search the environment stack for any environments or supplements corresponding to the current state of the present environment or supplement. For example, the environment or supplement may be established with a state machine that identifies, for each possible state, which other environments and supplements should receive state updates. As another example, the environment or supplement may be established with a simple list of associated environments and supplements. Next, in step 1340, the environment or supplement sends state updates to any identified correspondent environments or supplements within the environment stack. To this end, the environments and supplements may implement a common state sharing interface, such that state information may be easily packaged, sent, and interpreted. Alternatively, the present environment or supplement may be configured to call specific functions provided by the correspondent environments and supplements to effect the desired change. Various other methods for implementing state sharing will be apparent.

It will be understood that the various systems and methods described herein may be applicable to fields outside of medicine. For example, the systems and methods described herein may be adapted to other models such as, for example, mechanical, automotive, aerospace, traffic, civil, or astronomical systems. Further, various systems and methods may be applicable to fields outside of demonstrative environments such as, for example, video gaming, technical support, or creative projects. In such alternative embodiments, the analogy of a microscope may not be adopted and different types of portal frames other than a microscope frame may be used. For example, in an automotive application, an “x-ray” or “cutaway” analogy portal frame may be employed to show a piston environment over top of an external engine block environment. Further, no analogy may be used, and the portal frame may simply be an inlaid frame for displaying some different environment from the environment underneath the frame. Various other applications will be apparent.

It should be apparent from the foregoing description that various exemplary embodiments of the invention may be implemented in hardware or software running on a processor. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media. Further, as used herein, the term “processor” will be understood to encompass a microprocessor, field programmable gate array (FPGA), application-specific integrated circuit (ASIC), or any other device capable of performing the functions described herein.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications may be effected while remaining within the spirit and scope of the invention. Accordingly, the foregoing disclosure, description, and figures are for illustrative purposes only and do not in any way limit the invention, which is defined only by the claims.

What is claimed is:

1. A method performed by an authoring device for creating a digital medical presentation, the method comprising:
displaying, on a display of the authoring device, a first representation of a first environment, wherein the first environment represents an anatomical structure;
receiving, via a user input interface of the authoring device, a first user input representing a request to initiate a portal;
in response to receiving the first user input, displaying, on the output device a first compound representation comprising:
the first representation of the first environment,
a portal frame, and
a second representation of a second environment, wherein the second environment represents the anatomical structure and is located within the portal frame; and
generating a video file, wherein the video file enables playback of the first compound representation.

2. The method of claim 1, wherein the first environment represents the anatomical structure at a first magnification level and the second environment represents the anatomical structure at a second magnification level that is greater than the first magnification level.

3. The method of claim 1, wherein, in the first compound representation, the portal frame and second representation partially occlude the first representation.

4. The method of claim 1, further comprising:
receiving, via a user input interface of the authoring device, a second user input representing a request to change an environment of the first compound representation; and
in response to receiving the second user input, displaying, on the output device a second compound representation comprising:
the first representation of the first environment,
the portal frame, and
a third representation of a third environment, wherein the third environment represents the anatomical structure, is located within the portal frame, and is different from the second representation;
whereby the video file additionally enables playback of the second compound representation.

5. The method of claim 4, wherein:
the portal frame comprises at least two magnification buttons representative of respective magnification levels;
the second user input comprises selection of a selected magnification button of the at least two magnification buttons; and
the third environment represents the anatomical structure at the magnification level represented by the selected magnification button.

6. The method of claim 1, further comprising:
receiving, via a user input interface of the authoring device, a second user input representing a request to modify the second environment; and
in response to receiving the second user input, effecting a first modification to the simulation underlying the second representation, whereby the video file additionally enables playback of the second representation after effecting the first modification to the second environment.

7. The method of claim 6, wherein the first modification comprises at least one of administering a medication, inducing a medical condition, simulating a slide stain, and simulating a treatment.

8. The method of claim 6, wherein:
the frame comprises a tool palette including at least a first button associated with the modification and a second button associated with no modification; and
the second user input comprises selection of the first button.

9. The method of claim 6, further comprising, in response to receiving the second user input:
identifying a second modification associated with the first modification; and
effecting the second modification to the first environment, whereby the video file additionally enables playback of the first representation as part of the first compound representation after effecting the second modification to the first environment.

10. The method of claim 6, wherein:
the second user input comprises the user repositioning the portal frame with respect to the first representation; and
the first modification comprises moving a camera associated with the second environment based on the repositioning of the portal frame, whereby the video file additionally enables playback of the second representation after effecting the movement of the camera.

11. A non-transitory machine-readable storage medium encoded with instructions for execution by an authoring device for creating a digital medical presentation, the non-transitory machine-readable storage medium comprising:
instructions for displaying, on a display of the authoring device, a first representation of a first environment, wherein the first environment represents an anatomical structure;
instructions for receiving, via a user input interface of the authoring device, a first user input representing a request to initiate a portal;
instructions for, in response to receiving the first user input, displaying, on the output device a first compound representation comprising:
the first representation of the first environment,
a portal frame, and
a second representation of a second environment, wherein the second environment represents the anatomical structure and is located within the portal frame; and
instructions for generating a video file, wherein the video file enables playback of the first compound representation.

12. The non-transitory machine-readable storage medium of claim 11, wherein the first environment represents the anatomical structure at a first magnification level and the second environment represents the anatomical structure at a second magnification level that is greater than the first magnification level.

13. The non-transitory machine-readable storage medium of claim 11, wherein, in the first compound representation, the portal frame and second representation partially occlude the first representation.

14. The non-transitory machine-readable storage medium of claim 11, further comprising:
instructions for receiving, via a user input interface of the authoring device, a second user input representing a request to change an environment of the first compound representation; and
instructions for in response to receiving the second user input, displaying, on the output device a second compound representation comprising:
the first representation of the first environment,
the portal frame, and
a third representation of a third environment, wherein the third environment represents the anatomical structure, is located within the portal frame, and is different from the second representation;
whereby the video file additionally enables playback of the second compound representation.

15. The non-transitory machine-readable storage medium of claim 14, wherein:
the portal frame comprises at least two magnification buttons representative of respective magnification levels;
the second user input comprises selection of a selected magnification button of the at least two magnification buttons; and
the third environment represents the anatomical structure at the magnification level represented by the selected magnification button.

16. The non-transitory machine-readable storage medium of claim 11, further comprising:
instructions for receiving, via a user input interface of the authoring device, a second user input representing a request to modify the second environment; and
instructions for, in response to receiving the second user input, effecting a first modification to the second environment, whereby the video file additionally enables playback of the second representation after effecting the first modification to the second environment.

17. The non-transitory machine-readable storage medium of claim 16, wherein the first modification comprises at least one of administering a medication, inducing a medical condition, simulating a slide stain, and simulating a treatment.

18. The non-transitory machine-readable storage medium of claim 16, wherein:
the frame comprises a tool palette including at least a first button associated with the modification and a second button associated with no modification; and
the second user input comprises selection of the first button.

19. The non-transitory machine-readable storage medium of claim 16, further comprising instructions for, in response to receiving the second user input:
identifying a second modification associated with the first modification; and
effecting the second modification to the first environment, whereby the video file additionally enables playback of the first representation as part of the first compound representation after effecting the second modification to the first environment.

20. The non-transitory machine-readable storage medium of claim 16, wherein:
the second user input comprises the user repositioning the portal frame with respect to the first representation; and
the first modification comprises moving a camera associated with the second environment based on the repositioning of the portal frame, whereby the video file additionally enables playback of the second representation after effecting the movement of the camera.
